(19) United States
(12) Patent Application Publication
(10) Pub. No.: US 2002/0149564 A1
(43) Pub. Date: Oct. 17, 2002

(54) Keypad joystick

(76) Inventors: Christian J. Simpson, Richmond (GB); Alan H. Vanner, Twickenham (GB)

Correspondence Address: Andrus Sceales Starke & Sawall, Suite 1100, 100 East Wisconsin Avenue, Milwaukee, WI, 53202-4178, US

(21) Appl. No.: 10/048,670

(22) PCT Filed: May 29, 2001
(86) PCT No.: PCT/GB01/02370

(30) Foreign Application Priority Data
Jun. 2, 2000 (GB) 0013310.8

(51) Int. Cl. G09G 5/08

(52) U.S. Cl. 345/161

(57) ABSTRACT

A keypad joystick (10) for use in operating a hand-held keypad of a device, such as a cellular telephone (38), to enable enhanced playability of electronic games by operating the keypad comprises actuating means (11) adapted to operate keys (44) of the keypad selectively and means (12) for locating the actuating means (11) relative to the keypad so that, in operation, only a single key (44) is operated.

This invention relates to a keypad joystick intended mainly, but not solely, for use in operating cellular telephone numeric keypads to enable enhanced playability of electronic games by operating the keys.

In U.S. Pat. No. 5,034,574 there is disclosed a joystick for a computer keyboard having a central hollow housing which loosely fits over a centre key of the keyboard and two or more spaced arms extending from the housing, the arrangement being such that movement of a joystick handle in a forward or rearward or sideways direction causes a lower protuberance at an end of an arm to contact a key of the keyboard adjacent the centre key thereby effecting operation of the contacted key.

With such known joysticks it is possible that more than only a single key may be actuated when the joystick is operated. This would be a disadvantage if used on a cellular telephone numeric keypad because the software is so basic that pressing two keys at once jams the game and prevents movement.

In each of WO-A-89/01356 and U.S. Pat. No. 4,575,591 there is disclosed a keypad joystick comprising actuating means adapted to operate keys of the keypad selectively and means for locating the actuating means relative to the keypad so that, in operation, only a single key is operated, the locating means including an aperture and the actuating means including an elongate component extending through the aperture.

The actuating means includes a plurality of resiliently biased levers which are engaged selectively by the elongate component such that the levers engage, and operate selectively, keys of the keypad.

A disadvantage of such known joysticks is that they are not suitable for use with cellular telephones because the actuating means of the joysticks are too cumbersome.

The present invention is characterised in that the locating means and the actuating means comprise complementary formations which co-operate to restrain rotation of the elongate member relative to a longitudinal axis thereof.

Following is a description, by way of example only and with reference to the accompanying drawings, of one method of carrying the invention into effect.

In the drawings:

FIG. 1 is a plan view from above of a lower portion of a cellular telephone,

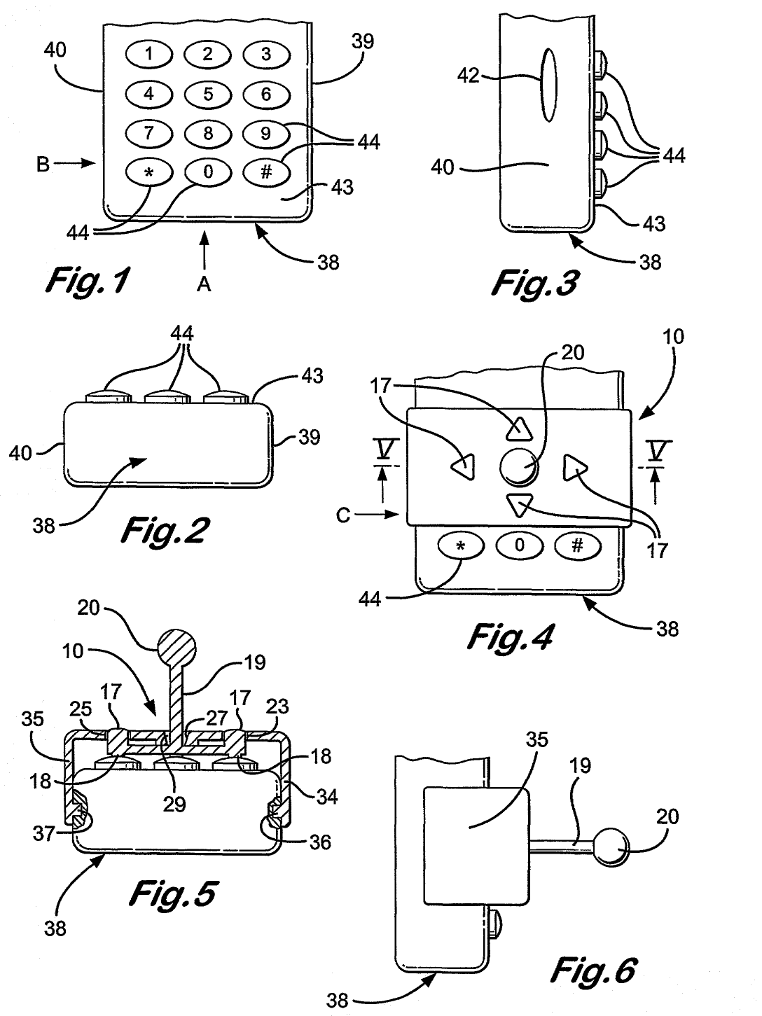

FIG. 2 is an end elevation of the telephone when viewed in the direction of the arrow “A” of FIG. 1,

FIG. 3 is a side elevation of the telephone when viewed in the direction of the arrow “B” of FIG. 1,

FIG. 4 is a plan view from above, corresponding to FIG. 1, of the telephone having attached thereto one embodiment of a joystick in accordance with the present invention,

FIG. 5 is a cross section of the joystick on the line V-V of FIG. 4,

FIG. 6 is a side elevation of the telephone and joystick combination when viewed in the direction of the arrow “C” of FIG. 4,

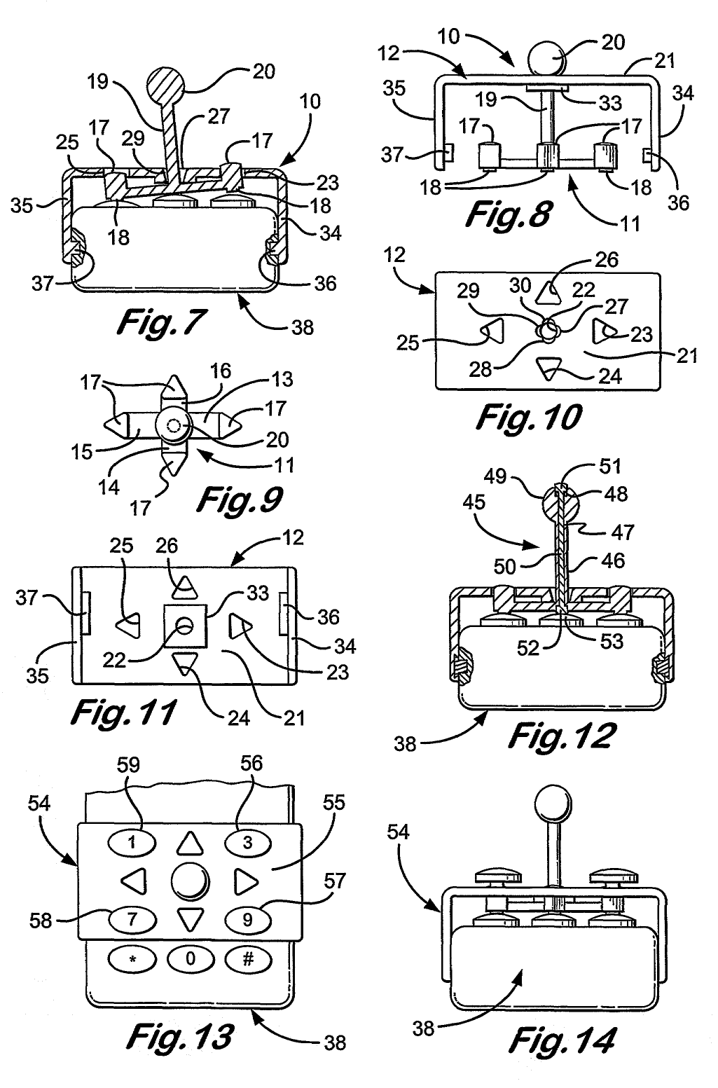

FIG. 7 is a view corresponding to FIG. 5 showing the joystick in operation,

FIG. 8 is a view corresponding to FIG. 5 showing the joystick with the telephone omitted,

FIG. 9 is a plan view from above of an actuating member of the joystick,

FIG. 10 is a diagrammatic plan view from above of a locating member of the joystick,

FIG. 11 is a plan view from below of the locating member of the joystick,

FIG. 12 is a view, corresponding to FIG. 5, of another embodiment of a joystick in accordance with the present invention, and

FIG. 13 and FIG. 14 are views corresponding to FIGS. 4 and 5 of another embodiment of a joystick in accordance with the present invention.

Referring now to FIGS. 8 to 11 of the drawings, there is shown a joystick 10 comprising an actuating member 11 and a locating member 12. The actuating member 11 comprises four elongate arms 13, 14, 15 and 16 each of the arms extending at right angles to an adjacent arm and each of the arms terminating in an upstanding end portion 17 having a lower protrusion 18. The formation comprising the arms 13 to 16 also includes an elongate stem 19 extending perpendicular to the plane containing the arms 13 to 16, a central longitudinal axis of the stem 19 intersecting central longitudinal axes of the arms 13 to 16. An upper end portion of the stem 19 is provided with a spherical operating handle 20.

The locating member 12 comprises an elongate rectangular panel 21 having a central aperture 22 and four surrounding apertures 23, 24, 25 and 26 each of triangular configuration each spaced equi-distant from an adjacent one of the additional apertures and from the central aperture, the apex of each triangular configuration extending towards a corresponding one of the four sides of the rectangular panel 21 and the base extending parallel to the side. The central aperture 22 is provided with four downwardly tapering cavities 27, 28, 29 and 30 each located adjacent a corresponding one of the four additional apertures 23 to 26. A lower surface of the panel 21 is provided with a rectangular area 33 of increased thickness surrounding the central aperture 22. The panel 21 is formed integrally with a pair of depending panels 34, 35 located at opposite end portions of the panel 21, lower end portions of the panels 34, 35 having inwardly directed protrusions 36, 37.

The actuating member 11 and the locating member 12 are assembled together such that the elongate stem 19 of the actuating member 11 extends through the central aperture 22 of the locating member 12, as shown in FIGS. 5 and 7.

The joystick 10 is intended for use in association with a cellular telephone 38 having side panels 39, 40 with recesses 41, 42 therein and an upper surface 43 having keys 44 located therein. The recesses 41,42 are already provided on the handsets primarily for snap-engagement in car mounted holders.

The cellular telephone 38 is of a type which is supplied with simple computer games pre-installed as part of its software operating system. Such games may be played by selectively operating four of the keys 44 which keys are located respectively above, below and on opposite sides of a central key. Prior to commencing playing the game, the joystick 10 is located on the cellular telephone 38 such that the elongate rectangular panel 21 of the locating member 12 bridges the keypad comprising the keys 44 and the protrusions 36, 37 of the side panels 34, 35 extending from the elongate rectangular panel 21 snap engage the corresponding recesses 41, 42 of the side panels 39, 40 of the telephone 38 whereby the protrusions 18 of the arms 13 to 16 are located respectively in contact with upper surfaces of the four keys which control operation of the game and the four upstanding end portions 17 of triangular configuration are located respectively in the four additional apertures 23 to 26 of triangular configuration in the elongate rectangular panel 21, as shown in FIG. 5.

The game is played by moving the operating handle 20 forwardly, or rearwardly or from side to side, that is in the direction of the apeces of the triangular configurations, such movement being possible due to the tapering cavities 27 to 30 extending from the central aperture 22, thereby pivoting the actuating member 11, as shown in FIG. 7, to operate the keys 44 selectively to play the game. This makes gameplay easier than before, when the user had to rely solely on rapid movement of thumb from key to key. This proved difficult as the wrong key was often pressed, or the thumb could not move quickly enough across several keys, resulting in lower scores. The joystick 10, however, makes rapid key changing far easier and quicker, resulting in the ability of the user to achieve vastly improved high scores—the very point of the game.

Co-operation between the triangular end portions 17 of the actuating member 11 and the triangular apertures 23 to 26 of the locating member 12 ensures that there is no angular movement of the elongate stem 19 relative to a longitudinal axis thereof and thereby ensures that movement of the handle 20 translates to an inline actuation against the keys 44. The co-operation also ensures that the handle 20 has to return to a central position before a subsequent key can be engaged thereby preventing multi-key actuation. The rectangular area 33 on the lower surface of the panel 21 provides four edges that the actuating member 11 can pivot upon relative to the locating member 12.

It will be appreciated, therefore, that the joystick 10 is adapted to take advantage of the pre-existing recesses 41, 42.

It will also be appreciated that the joystick 10 may easily be located on the cellular telephone 38 and easily removed therefrom.

It will also be appreciated that the length of the elongate stem 19 corresponds substantially to the depth of the panels 34, 35 of the locating member 12, as shown in FIG. 8, providing for compact storage of the joystick 10 when the joystick 10 is not in use on the cellular telephone 38.

The depth of the panels 34, 35 may be adjustable so that the joystick 10 may be located on cellular telephones having different dimensions.

Furthermore, it will be appreciated that the side panels 34, 35 of the locating member 12 may be adapted to clip on sides of the telephone 38 rather than engage with recesses 39, 40 thereof, such an arrangement would be suitable for use with a telephone not provided with side recesses corresponding to the recesses 41, 42.

Referring now to FIG. 12 of the drawings, there is shown a joystick 45 which is similar to the joystick 10 except that the stem 46 of the joystick 45 is provided with a longitudinal bore 47 which opens into a recess 48 in the spherical operating handle 49. The bore 47 contains a pin 50 which extends longitudinally of the bore 47 and upper and lower end portions of the pin 50 are enlarged to provide an upper button 51 and a lower strike surface 52.

The arrangement is such that, in use, the strike surface 52 is located juxtaposed a key 53 of the keypad of the cellular telephone 38, operation of which key 53 effects a “firing” signal in the game. Therefore, operation of downward pressure on the button 51, the “fire” button, effects operation of the key 53 of the keypad.

Referring now to FIGS. 13 and 14 of the drawings, there is shown a joystick 54 which is similar to the joystick 10 except that the rectangular panel 55 is provided with four buttons 56, 57, 58 and 59 adapted to operate respective keys of the keypad located below the respective buttons 56 and 59.

The purpose of providing the buttons 56 and 59 is to provide an extra facility so that the joystick 54 may be used for playing games which require the use of additional buttons.

It will be appreciated that a keypad joystick in accordance with the present invention may be utilised in respect of keypads other than for cellular telephones. For example, the joystick may be utilised to enhance game playability on other handheld devices such as digital television remote controls and palmtop computers.

1. A keypad joystick comprising actuating means (11) adapted to operate keys (44) of the keypad selectively and means (12) for locating the actuating means (11) relative to the keypad so that, in operation, only a single key (44) is operated, the locating means (12) including an aperture (22) and the actuating means (11) including an elongate component (19) extending through the aperture (22) characterised in that the locating means (12) and the actuating means (11) comprise complementary formations (17; 23, 24, 25, 26) which co-operate to restrain rotation of the elongate component (19) relative to a longitudinal axis thereof.

2. A joystick as claimed in claim 1 characterised in that the locating means (12) is adapted to bridge the keypad.

3. A joystick as claimed in claim 2 characterised in that the locating means (12) is adapted to locate in recesses (41, 42) provided on opposite sides of a cellular telephone (38).

4. A joystick as claimed in claim 4 or claim 5 wherein the locating means is adjustable so as to locate on cellular telephones of different dimensions.

5. A joystick as claimed in any one of the preceding claims characterised in that the actuating means (45) includes a firing button (50, 51, 52).

6. A joystick as claimed in any one of the preceding claims characterised in that the locating means (55) is provided with a plurality of buttons (56, 57, 58, 59) adapted to operate respective keys (44) of the keypad.
